(19) United States
(12) Patent Application Publication
(10) Pub. No.: US 2005/0236607 A1
(43) Pub. Date: Oct. 27, 2005

(54) Composite cribbing

(75) Inventor: Cris E. Pasto, Spencer, NY (US)

Correspondence Address: AQUILLA & ASSOCIATES, 88 LOWER CREEK ROAD, ITHACA, NY, 14850, US

(73) Assignee: Res-Q-Jack, Inc., Elmira, NY (US)

(21) Appl. No.: 11/115,741

(22) Filed: Apr. 27, 2005

Related U.S. Application Data
(60) Provisional application No. 60/565,619, filed on Apr. 27, 2004.

(51) Int. Cl. B66F 1/00

(52) U.S. Cl. 254/104

(57) ABSTRACT

An improved cribbing apparatus for placement at selected locations at a site of an accident to stabilize a post-accident vehicle against unwanted shifting on ground located at the accident site during rescue of a victim trapped in the vehicle, the cribbing apparatus includes a composite cribbing having a wedge shape with a forward end, a rearward end spaced longitudinally from the forward end, an upper surface, and a lower surface spaced altitudinally from the upper surface, wherein the composite cribbing includes a core of plastic or a substantially non-compliant material, and a skin of wood, rubber, or a substantially compliant material on the upper and/or lower surfaces thereof.

### REFERENCE TO RELATED APPLICATIONS

This application claims an invention, which was disclosed in Provisional Application No. 60/565,619, filed Apr. 27, 2004, entitled “IMPROVED RESCUE TOOLS”. The benefit under 35 USC § 119(e) of the United States provisional application is hereby claimed, and the aforementioned provisional application is hereby incorporated herein by reference in its entirety.

### BACKGROUND OF THE INVENTION

1. Field of the Invention

The invention pertains to the field of emergency rescue and shoring devices. More particularly, the invention pertains to a composite cribbing apparatus useful for stabilizing a side-resting or roof-resting motor vehicle, such as for access by rescue workers, during extrication of accident victims from the vehicles.

2. Description of Related Art

A side-resting or roof-resting motor vehicle can be a difficult situation for rescue teams, particularly in terms of vehicle stabilization. In any vehicle stabilization effort, quick and simple solutions are desired; time spent on vehicle stabilization is time not spent on victim extrication and patient care. However, what often is overlooked is that most of the known quick and simple techniques for stabilizing a roof-resting vehicle interfere with access to the passenger compartment. Many of these techniques Include the step of attaching restraint straps to the rear posts of the vehicle, or running straps across the door up to the undercarriage of the vehicle, thus limiting accident victim extrication options.

Another problem inherent in the stabilization of a side-resting or roof-resting vehicle is that the locations most desired to place stabilization stands typically are the least conducive to a good purchase. For example, in many situations, the engine weight of the vehicle keeps the nose down and the rear end up, leaving a sloped slippery surface with little for a prop tip to engage. The rear of a typical sedan, for example, provides very few solid locations for stand engagement. Examples of areas that typically lend themselves to purchase include fender light knockouts in fenders, gas fill openings, rear trunk walls, tail light knockouts, and some bumpers or bumper supports. Often one can punch out the rear fender lights, thus leaving a hole in the fender as a purchase point.

Depending on vehicle condition, because of the collision, the presence of rust, and/or vehicle material composition, one may be able to gain a purchase sufficient to remove “play” in the vehicle. However, if vertical support is necessary, this could be a problem with sheet metal or plastic materials, particularly if the fenders provide the only available purchase. If one opens the gas fill door, one may find a good purchase there. Unfortunately, a gas fill door typically is available only on one side of the vehicle (although some models of vehicles have them on two sides, but this is a rare exception). Furthermore, if fuel is leaking, this will have to be addressed also, as setting the metal stand against a metal fender could possibly cause ignition.

The rear trunk wall usually provides a good grip for a channel-type end fitting. However, gaining access to the trunk wall often is difficult, unless the trunk lid is removed. Bumpers are another typical option, but come in many shapes and materials. Some are strong, some are weak. Bumper supports vary considerably as well. One technique, which is very quick to employ, is to place a single stand centered in the rear of the vehicle, in conjunction with step blocking or wedges in front of the ‘A’ posts. This provides three points of stabilization. However, two of the points, the wedges, are low relative to the center of gravity of the vehicle, and do little to increase the vehicle footprint.

Note that a roof-resting vehicle has a much lower center of gravity in comparison with a side-resting vehicle, as well as a wider footprint to start with. The use of wedges does, however, increase good solid ground contact. An advantage to this type of system is that the prop purchase is typically a solid one with the rear trunk wall or a solid bumper, and the base is well restrained. However, there are several disadvantages with this type of system. To restrain the base properly, the straps typically are hooked at either the rear posts, or run up the sides to the vehicle undercarriage. Attaching to the rear posts can in some situations cause difficulty in roof removal. Further, straps that run up the sides in front of the doors limit access from the sides. In addition, the stand itself is centered in the rear of the vehicle, thus hampering access to the rear window.

Another known method is to apply a stand at each fender, again preferably with wedges in front of the ‘A’ post. With a good purchase, this can be sufficient stabilization in some cases. With this system, the base strap of one stand is connected to the opposite stand base. Disadvantages with this system include the purchase difficulties mentioned above, and the fact that the bases are not restrained completely. If the vehicle can be restrained from sliding, the lack of sideward base restraint most likely will not be an issue. An advantage to this system is that the passenger compartment is left relatively unobstructed.

Another known technique is to combine the previous two methods, thus providing a stand at both rear fenders and a stand at the rear center, along with the wedge cribbing at the ‘A’ post. Restraint straps can be configured in a few different ways. One strapping configuration is to strap the fender stand bases to each other independent of the rear stand, and to strap the rear stand base to the rear roof posts using ‘J’ hooks. Another method is to strap the rear stand to the fender stands, and then strap the fender stands to the rear post. In addition, the fender stands may be strapped to each other. In this configuration, the straps connected to the rear posts can be moved to the front of the vehicle, thus leaving the passenger compartment unobstructed. The final strap configuration noted above keeps extrication options open, however, the difficulty of finding quick and solid stand engagement remains a problem.

During a vehicle rescue situation, it is often necessary to remove the doors and/or roof of the vehicle to gain access and free patients. When the car is resting normally on its wheels, this is a simple operation with few concerns of any problems. However, when the car is resting on its roof, complete roof and door removal may lead to a failure, bending, or collapse of the floor pan which could injure the occupants and/or rescue team. One known technique for preventing such a problem is to place support stands or cribbing from the ground up to the floor pan of the vehicle, supporting the area from which the doors were removed. One problem with this approach, however, is that the support components cannot be placed until the vehicle parts (doors and/or roof) have been removed. This typically allows for a short time period with no support, which could potentially lead to a collapse. Another problem with the prior supporting technique is that it places equipment in the way of patient access and removal.

Cribbing typically is used as an aid to stabilization of unstable objects or structures in rescue operations and/or construction. Prior art cribbing is dominantly composed of wood or plastic. Wood offers a rugged, inexpensive option, which has some compliance to assist in gripping an object when under load. However, wood can become contaminated with hazardous materials or bodily fluids. Additionally, it is often difficult to cut a wedge, which is a desirable shape for one form of cribbing. Wood also can be damaged easily or decompose over time. Prior art plastic wedges overcome many of the problems associated with wood, however, a big disadvantage to the plastic wedges is the tendency to slip out, as the plastic is not as compliant as wood and the surface of the plastic materials is usually is slick, particularly if the plastic wedge is contaminated with lubricant or other fluids leaking from a damaged vehicle.

U.S. Pub. No. 2004/0261356 discloses a self-supportive panel system, used to fabricate ceilings, floors, walls or roofs. The panel system is assembled from a plurality of panels, each having a core that is sandwiched between opposing plate members. In a preferred embodiment, the core of each panel includes a unifying material to enhance the load bearing capacity of the panel.

U.S. Pat. No. 6,354,569 discloses a cribbing apparatus for stabilizing a post-accident vehicle against unwanted shifting of the vehicle during a rescue operation in which a victim trapped in the vehicle is to be extricated. The apparatus includes cribbing blocks hinged together for pivotal movement to fill a space between the vehicle and the ground at the site of an accident. A wedge is inserted between the pivotally connected cribbing blocks for operating the cribbing apparatus without jolts and dislocations which otherwise could cause shifting and concomitant increased danger of injury to the victim, as well as to a rescuer.

U.S. Pat. No. 5,270,108 discloses an insulated building panel for use in residential or commercial construction, comprising a core of expanded polystyrene (EPS) bonded to at least two exterior skins of oriented strand board by a urethane laminating adhesive and treated with a sodium borate, such as disodium octaborate tetrahydrate, to preserve and protect the building panels from attack by many types of insects, molds and fungi.

U.S. Pat. No. 4,917,219 discloses a light-weight wheel chock, having a thin exterior shell of rigid, chemically-inert plastic material, such as high-density polyethylene, and an interior cavity filled with light-weight rigid or semi-rigid foam, such as high-density polyurethane foam. The wheel chock is of a permanently bonded unitary construction, made from multiple materials. An outside core consists of several holes intended for filling the core with a secondary material.

U.S. Pat. No. 3,381,937 discloses a wedge comprising a body formed from laminated wood, and a stainless steel sheath covering the forward portion. The wedge is designed to be slippery: “the metal sleeve over the thin end of the wedge is to provide a slippery surface as well as structural support to the leading edge of the wedge.”

U.S. Pat. No. 2,764,516 discloses a method of forming laminated structures having a thermosetting resin formed therebetween.

Thus, the known cribbing devices suffer from various drawbacks and therefore fail to provide adequate stabilization for rescue situations, and an improved cribbing apparatus is needed in the art

### SUMMARY OF THE INVENTION

The present invention provides a composite cribbing apparatus for stabilizing a side-resting or roof-resting motor vehicle, which is useful for emergency rescue workers who must stabilize a damaged vehicle and assist in removing the accident victims.

According to a preferred aspect of the present invention, herein is disclosed an improved composite cribbing apparatus for placement at selected locations at a site of an accident to stabilize a post-accident vehicle against unwanted shifting on ground located at the accident site during rescue of a victim trapped in the vehicle. In one embodiment, the cribbing apparatus includes a composite cribbing having a wedge shape with a forward end, a rearward end spaced longitudinally from the forward end, an upper surface, and a lower surface spaced altitudinally from the upper surface, wherein the composite cribbing includes a core of plastic or a substantially non-compliant material, and a skin of wood, rubber, or a substantially compliant material on the upper and/or lower surfaces thereof.

The present invention overcomes the limitations of known plastic and wooden cribbing devices, and provides quick, simple means for stabilizing a vehicle. The skins of the composite cribbing are easily replaceable if, for example, the wood surface becomes contaminated or rotted.

These and other features and advantages will become readily apparent from the following Detailed Description, which should be read in conjunction with the accompanying drawings.

### BRIEF DESCRIPTION OF THE DRAWING

FIG. 1 shows a side view of a composite cribbing apparatus, according to an embodiment of the invention.

### DETAILED DESCRIPTION OF THE INVENTION

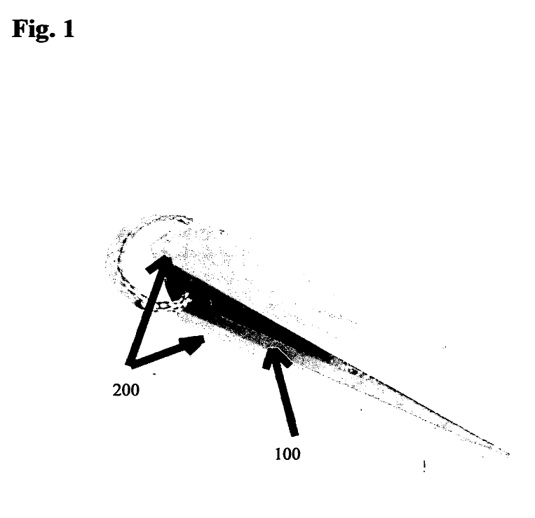

Referring now to FIG. 1, an embodiment of a cribbing apparatus according to the invention is shown. In the preferred embodiment, the composite cribbing of the invention is a combination of two or more materials. For example, one embodiment comprises a skin (200) of wood, rubber, or other material preferably more compliant than plastic, and a core (100) of preferably plastic or other substantially non-compliant material. In this embodiment, the composite cribbing includes of a plastic core shaped as desired (e.g., wedge) with a replaceable skin of wood, or other relatively compliant non-plastic material. In one embodiment, the wood skin is a commercially available piece of wood, which would require merely one simple crosscut to prepare. For example, the wood skin optionally is fabricated from a solid wood board, plywood, particleboard, oriented strand board, or any other wood product. The wood skin is affixed to the plastic wedge core, preferably by reversible means, such as, for example, by using glue or epoxy. The reversible feature eliminates the need to discard the entire component, when the wood skin becomes contaminated with vehicle fluids or hazardous bodily fluids at an accident scene. That is, rather than replacing the entire unit, the wood skin can simply be replaced with a new one. This embodiment also eliminates the need to make complicated cuts when preparing a wedge.

One suitable component for preparing the composite cribbing of the present invention is an existing plastic wedge, which is commonly produced by several manufacturers, and placing a replaceable rough wood skin on the top and bottom surfaces. One reason for this is that the plastic wedges typically are slippery, particularly when vehicle fluids at a crash scene contact the plastic wedge. Therefore, cribbing made entirely of plastic has this substantial problem. Alternatively, one could simply make the whole wedge from wood, however, accurately making a good wood wedge can be difficult, particularly when made with equipment that is readily available to the typical fireman or rescue worker. For example, standard circular saws typically do not have the necessary cut depth required to make a suitable wedge. Further, cutting with a chainsaw or reciprocating saber saw (e.g., Sawzall®) generally is inaccurate. However, it is a relatively simple operation for one to cut rectangular shapes from thinner wood boards or plywood. The existing plastic wedges make for a durable reusable wedge shaped core for attachment of the replaceable (disposable) wood skins. The skin should not hang over the edge of the core, as this is likely to lead to failure of the composite cribbing.

The known plastic wedges typically are manufactured from recycled plastics, such as high-density polyethylene (HDPE) and are flow formed in molds. However, any substantially rigid, non-compliant plastic material is suitable for the present application.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A cribbing apparatus for placement at selected locations at a site of an accident to stabilize a post-accident vehicle against unwanted shifting on ground located at the accident site during rescue of a victim trapped in the vehicle, the cribbing apparatus comprising:
a composite cribbing having a wedge shape with a forward end, a rearward end spaced longitudinally from the forward end, an upper surface, and a lower surface spaced altitudinally from the upper surface;
wherein said composite cribbing comprises a core of plastic or a substantially non-compliant material, and a skin of wood, rubber, or a substantially compliant material on the upper and/or lower surfaces thereof.

2. The cribbing apparatus of claim 1, wherein said skin is affixed to said upper and lower surfaces.

3. The cribbing apparatus of claim 1, wherein said skin is affixed to said core using glue, epoxy or cement.

4. The cribbing apparatus of claim 1, wherein said skin is reversibly affixed to said core.

5. The cribbing apparatus of claim 1, wherein said skin spans said core from said forward end to said rearward end.

6. The cribbing apparatus of claim 5, wherein said skin does not hang over the edge of the core.

7. The cribbing apparatus of claim 1, wherein the wedge is a single rigid unit including a plastic core with wood skins rigidly affixed to the upper and lower surfaces thereof.
